(19) United States
(12) Patent Application Publication
(10) Pub. No.: US 2011/0235582 A1
(43) Pub. Date: Sep. 29, 2011

(54) SUBFRAME DEPENDENT TRANSMISSION POWER CONTROL FOR INTERFERENCE MANAGEMENT

(75) Inventors: Wanshi Chen, San Diego, CA (US); Tingfang Ji, San Diego, CA (US)

(73) Assignee: QUALCOMM INCORPORATED, San Diego, CA (US)

(21) Appl. No.: 13/070,862

(22) Filed: Mar. 24, 2011

Related U.S. Application Data
(60) Provisional application No. 61/317,648, filed on Mar. 25, 2010.

(51) Int. Cl. H04W 52/08

(52) U.S. Cl. 370/328

(57) ABSTRACT

According to certain aspects, transmission power control may be applied to uplink transmissions in a subframe-type dependent manner as part of an interference management scheme.

### CROSS-REFERENCE TO RELATED APPLICATIONS

This application claims priority to U.S. Provisional Application Ser. No. 61/317,648, entitled “SYSTEMS, APPARATUS AND METHODS TO FACILITATE SUBFRAME DEPENDENT NOISE PADDING FOR INTERFERENCE MANAGEMENT,” filed on Mar. 25, 2010, which is expressly incorporated by reference herein in its entirety.

### BACKGROUND

I. Field

The present disclosure generally relates to communication and, more specifically, to techniques for managing interference by controlling transmission power.

II. Background

Wireless communication networks are widely deployed to provide various communication content such as voice, video, packet data, messaging, broadcast, etc. These wireless networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

A wireless communication network may include a number of base stations that may support communication for a number of user equipments (UEs). A UE may communicate with a base station via the downlink and uplink. The downlink (or forward link) refers to the communication link from the base station to the UE, and the uplink (or reverse link) refers to the communication link from the UE to the base station.

A base station may transmit data to one or more UEs on the downlink and may receive data from one or more UEs on the uplink. On the downlink, a data transmission from the base station may observe interference due to data transmissions from neighbor base stations. On the uplink, a data transmission from a UE may observe interference due to data transmissions from other UEs communicating with the neighbor base stations. For both the downlink and uplink, the interference due to the interfering base stations and the interfering UEs may degrade performance.

### SUMMARY

According to certain aspects, a method for mitigating interference in a wireless communications network is provided. The method generally includes obtaining power control information and adjusting transmit power of transmissions sent during subframes of different types based on the power control information, wherein the subframe types comprise at least a first type in which transmissions in a first cell are protected by restricting transmissions in a second cell.

According to certain aspects, a method for mitigating interference in a wireless communications network is provided. The method generally includes determining power control information and transmitting the power control information to a user equipment for use in adjusting transmit power of transmissions sent during subframes of different types based on the power control information, wherein the subframe types comprise at least a first type in which transmissions in a first cell are protected by restricting transmissions in a second cell.

Various aspects and features of the disclosure are described in further detail below.

### BRIEF DESCRIPTION OF THE DRAWINGS

FIG. 1 shows a wireless communication network.

FIG. 2 shows a block diagram of a base station and a UE.

FIG. 3 shows a frame structure for frequency division duplexing (FDD).

FIG. 4 shows two exemplary subframe formats for the downlink.

FIG. 5 shows an exemplary subframe format for the uplink.

FIG. 6 shows a frame structure for time division duplexing (TDD).

FIG. 7 shows example functional components of a base station and a UE, in accordance with certain aspects of the present disclosure.

FIG. 8 illustrates example operations that may be performed by a UE, in accordance with certain aspects of the present disclosure.

FIG. 9 illustrates example operations that may be performed by a BS, in accordance with certain aspects of the present disclosure.

FIGS. 10A and 10B illustrate how separate power control loops may be utilized for different subframe types to manage interference, in accordance with certain aspects of the present disclosure.

### DETAILED DESCRIPTION

Techniques for managing interference by controlling transmission power are described herein. According to certain aspects, transmit power of transmissions sent during subframes of different types is controlled as a function of the subframe type. As an example, the subframe types may include a first type in which transmissions in a first cell are protected by restricting transmissions in a second cell and a second type in which transmissions in the first cell are not so protected. The protection afforded the first type of subframe may allow a lower transmit power to be used while a relatively higher transmit power may be used in subframes of the second type of subframe to overcome potential interference by transmissions in the second cell.

The techniques described herein may be used for various wireless communication networks such as CDMA, TDMA, FDMA, OFDMA, SC-FDMA and other networks. The terms “network” and “system” are often used interchangeably. A CDMA network may implement a radio technology such as Universal Terrestrial Radio Access (UTRA), cdma2000, etc. UTRA includes Wideband CDMA (WCDMA), Time Division Synchronous CDMA (TD-SCDMA), and other variants of CDMA. cdma2000 covers IS-2000, IS-95, and IS-856 standards. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM®, etc. UTRA and E-UTRA are part of Universal Mobile Telecommunication System (UMTS). 3GPP Long Term Evolution (LTE) and LTE-Advanced (LTE-A), in both frequency division duplex (FDD) and time division duplex (TDD), are new releases of UMTS that use E-UTRA, which employs OFDMA on the downlink and SC-FDMA on the uplink. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). The techniques described herein may be used for the wireless networks and radio technologies mentioned above as well as other wireless networks and radio technologies. For clarity, certain aspects of the techniques are described below for LTE, and LTE terminology is used in much of the description below.

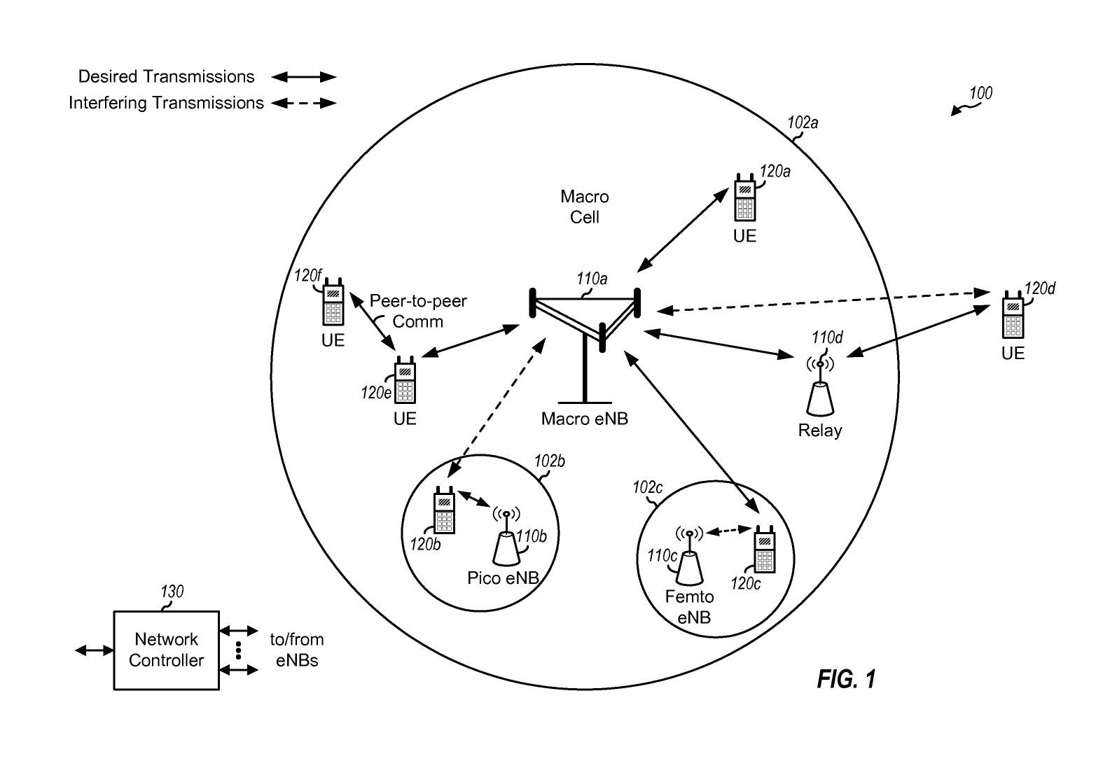

FIG. 1 shows a wireless communication network 100, which may be an LTE network or some other wireless network. The interference management techniques presented herein may be used in such a system.

Wireless network 100 may include a number of evolved Node Bs (eNBs) 110 and other network entities. An eNB may be an entity that communicates with the UEs and may also be referred to as a base station, a Node B, an access point, etc. Each eNB may provide communication coverage for a particular geographic area. In 3GPP, the term “cell” may refer to a coverage area of an eNB and/or an eNB subsystem serving this coverage area, depending on the context in which the term is used.

An eNB may provide communication coverage for a macro cell, a pico cell, a femto cell, and/or other types of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a Closed Subscriber Group (CSG)). An eNB for a macro cell may be referred to as a macro eNB. An eNB for a pico cell may be referred to as a pico eNB. An eNB for a femto cell may be referred to as a home eNB (HeNB) or a femto eNB. In the example shown in FIG. 1, an eNB 110a may be a macro eNB for a macro cell 102a, an eNB 110b may be a pico eNB for a pico cell 102b, and an eNB 110c may be a femto eNB for a femto cell 102c. An eNB may support one or multiple (e.g., three) cells. The terms “eNB”, “base station”, and “cell” may be used interchangeably herein.

Wireless network 100 may also include relays. A relay may be an entity that may receive a transmission of data from an upstream station (e.g., an eNB or a UE) and send a transmission of the data to a downstream station (e.g., a UE or an eNB). A relay may also be a UE that may relay transmissions for other UEs. In the example shown in FIG. 1, a relay 110d may communicate with macro eNB 110a via a backhaul link and with a UE 120d via an access link in order to facilitate communication between eNB 110a and UE 120d. A relay may also be referred to as a relay eNB, a relay station, a relay base station, etc.

Wireless network 100 may be a heterogeneous network that includes eNBs of different types, e.g., macro eNBs, pico eNBs, femto eNBs, relay eNBs, etc. These different types of eNBs may have different transmit power levels, different coverage sizes, and different impact on interference in wireless network 100. For example, macro eNBs may have a high transmit power level (e.g., 5 to 40 Watts) whereas pico eNBs, femto eNBs, and relays may have lower transmit power levels (e.g., 0.1 to 2 Watts).

A network controller 130 may couple to a set of eNBs and may provide coordination and control for these eNBs. Network controller 130 may comprise a single network entity or a collection of network entities. Network controller 130 may communicate with the eNBs via a backhaul. The eNBs may also communicate with one another, e.g., directly or indirectly via a wireless or wireline backhaul.

UEs 120 may be dispersed throughout wireless network 100, and each UE may be stationary or mobile. A UE may also be referred to as a mobile station, a terminal, an access terminal, a subscriber unit, a station, etc. A UE may be a cellular phone, a personal digital assistant (PDA), a wireless modem, a wireless communication device, a handheld device, a laptop computer, a cordless phone, a wireless local loop (WLL) station, a smart phone, a netbook, a smartbook, etc. A UE may be able to communicate with macro eNBs, pico eNBs, femto eNBs, relays, etc. A UE may also be able to communicate peer-to-peer (P2P) with another UE. In the example shown in FIG. 1, UEs 120e and 120f may communicate directly with each other without communicating with an eNB in wireless network 100. P2P communication may reduce the load on wireless network 100 for local communications between UEs. P2P communication between UEs may also allow one UE to act as a relay for another UE, thereby enabling the other UE to connect to an eNB.

In FIG. 1, a solid line with double arrows indicates desired transmissions between a UE and a serving eNB, which is an eNB designated to serve the UE on the downlink and/or uplink. A dashed line with double arrows indicates interfering transmissions between a UE and an eNB.

A UE may be located within the coverage of multiple eNBs. One of these eNBs may be selected to serve the UE. The serving eNB may be selected based on various criteria such as received signal strength, received signal quality, pathloss, etc. Received signal quality may be quantified by a signal-to-noise-and-interference ratio (SINR), or a reference signal received quality (RSRQ), or some other metric.

A UE may operate in a dominant interference scenario in which the UE may observe high interference from one or more interfering eNBs. A dominant interference scenario may occur due to restricted association. For example, in FIG. 1, UE 120c may be close to femto eNB 110c and may have high received power for eNB 110c. However, UE 120c may not be able to access femto eNB 110c due to restricted association and may then connect to macro eNB 110a with lower received power. UE 120c may then observe high interference from femto eNB 110c on the downlink and may also cause high interference to femto eNB 110c on the uplink.

A dominant interference scenario may also occur due to range extension, which is a scenario in which a UE connects to an eNB with lower pathloss and possibly lower SINR among all eNBs detected by the UE. For example, in FIG. 1, UE 120b may be located closer to pico eNB 110b than macro eNB 110a and may have lower pathloss for pico eNB 110b. However, UE 120b may have lower received power for pico eNB 110b than macro eNB 110a due to a lower transmit power level of pico eNB 110b as compared to macro eNB 110a. Nevertheless, it may be desirable for UE 120b to connect to pico eNB 110b due to the lower pathloss. This may result in less interference to the wireless network for a given data rate for UE 120b.

Various interference management techniques may be used to support communication in a dominant interference scenario. These interference management techniques may include semi-static resource partitioning (which may be referred to as inter-cell interference coordination (ICIC)), dynamic resource allocation, interference cancellation, etc. Semi-static resource partitioning may be performed (e.g., via backhaul negotiation) to allocate resources to different cells. The resources may comprise subframes, subbands, carriers, resource blocks, transmit power, etc. Each cell may be allocated a set of resources that may observe little or no interference from other cells or their UEs. Dynamic resource allocation may also be performed (e.g., via exchange of over-the-air messages between cells and UEs) to allocate resources as needed to support communication for UEs observing strong interference on the downlink and/or uplink. Interference cancellation may also be performed by UEs to mitigate interference from interfering cells.

Wireless network 100 may support hybrid automatic retransmission (HARQ) for data transmission on the downlink and uplink. For HARQ, a transmitter (e.g., an eNB) may send one or more transmissions of a packet until the packet is decoded correctly by a receiver (e.g., a UE) or some other termination condition is encountered. For synchronous HARQ, all transmissions of the packet may be sent in subframes of a single HARQ interlace, which may include every Q-th subframes, where Q may be equal to 4, 6, 8, 10, or some other value. For asynchronous HARQ, each transmission of the packet may be sent in any subframe.

Wireless network 100 may support synchronous or asynchronous operation. For synchronous operation, the eNBs may have similar frame timing, and transmissions from different eNBs may be approximately aligned in time. For asynchronous operation, the eNBs may have different frame timing, and transmissions from different eNBs may not be aligned in time.

Wireless network 100 may utilize FDD or TDD. For FDD, the downlink and uplink may be allocated separate frequency channels, and downlink transmissions and uplink transmissions may be sent concurrently on the two frequency channels. For TDD, the downlink and uplink may share the same frequency channel, and downlink and uplink transmissions may be sent on the same frequency channel in different time periods.

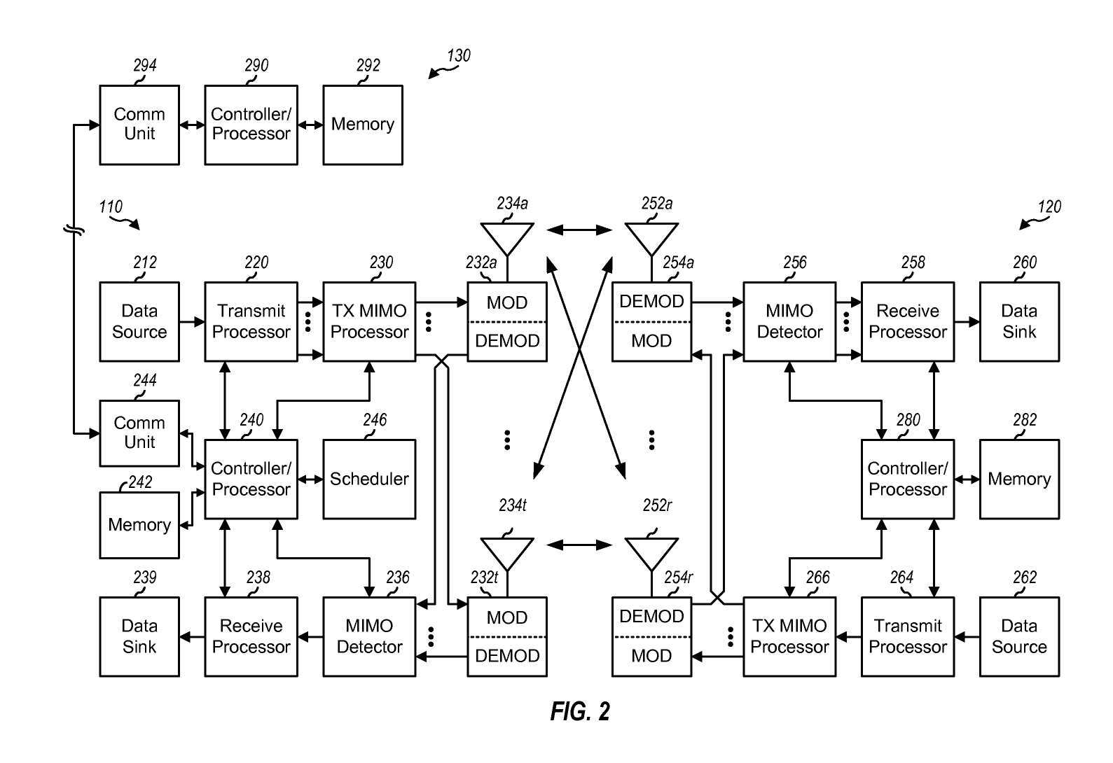

FIG. 2 shows a block diagram of a design of a base station/eNB 110 and a UE 120, which may be one of the base stations/eNBs and one of the UEs in FIG. 1. The various components (e.g., processors) shown in FIG. 2 may be utilized to perform the interference management techniques described herein. As illustrated, the base station 110 may transmit power control information 202 to the UE 120. As will be described in greater detail below, the UE 120 may adjust the transmit power of uplink transmissions in a subframe-dependent manner based on the power control information 202.

Base station 110 may be equipped with T antennas 234a through 234t, and UE 120 may be equipped with R antennas 252a through 252r, where in general T≧1 and R≧1.

At base station 110, a transmit processor 220 may receive data from a data source 212 for one or more UEs and control information from a controller/processor 240. Processor 220 may process (e.g., encode and modulate) the data and control information to obtain data symbols and control symbols, respectively. Processor 220 may also generate reference symbols for synchronization signals, reference signals, etc. A transmit (TX) multiple-input multiple-output (MIMO) processor 230 may perform spatial processing (e.g., precoding) on the data symbols, the control symbols, and/or the reference symbols, if applicable, and may provide T output symbol streams to T modulators (MODs) 232a through 232t. Each modulator 232 may process a respective output symbol stream (e.g., for OFDM, etc.) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively.

At UE 120, antennas 252a through 252r may receive the downlink signals from base station 110, downlink signals from other base stations, and/or P2P signals from other UEs and may provide received signals to demodulators (DEMODs) 254a through 254r, respectively. Each demodulator 254 may condition (e.g., filter, amplify, downconvert, and digitize) a respective received signal to obtain input samples. Each demodulator 254 may further process the input samples (e.g., for OFDM, etc.) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information to a controller/processor 280.

On the uplink, at UE 120, a transmit processor 264 may receive data from a data source 262 and control information from controller/processor 280. Processor 264 may process (e.g., encode and modulate) the data and control information to obtain data symbols and control symbols, respectively. Processor 264 may also generate reference symbols for one or more reference signals, etc. The symbols from transmit processor 264 may be precoded by a TX MIMO processor 266 if applicable, further processed by modulators 254a through 254r (e.g., for SC-FDM, OFDM, etc.), and transmitted to base station 110, other base stations, and/or other UEs. At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120 and other UEs. Processor 238 may provide the decoded data to a data sink 239 and the decoded control information to controller/processor 240.

Controllers/processors 240 and 280 may direct the operation at base station 110 and UE 120, respectively. Processor 240 and/or other processors and modules at base station 110 may perform or direct processing for the techniques described herein. Processor 280 and/or other processors and modules at UE 120 may perform or direct processing for the techniques described herein. Memories 242 and 282 may store data and program codes for base station 110 and UE 120, respectively. A communication (Comm) unit 244 may enable base station 110 to communicate with other network entities (e.g., network controller 130). A scheduler 246 may schedule UEs for data transmission on the downlink and/or uplink.

According to certain aspects, the receive processor 238 and/or controller/processor 240 may determine the power control information and provide this information to the transmit processor 220 for transmission to the UE 120. In turn, the receive processor 258 and/or controller processor 280 of the UE 120 may extract the power control information and provide it to the transmit processor 264 for use in controlling transmit power for uplink transmissions in a subframe dependent manner.

FIG. 2 also shows a design of network controller 130 in FIG. 1. Within network controller 130, a controller/processor 290 may perform various functions to support communication for UEs. Controller/processor 290 may perform processing for the techniques described herein. A memory 292 may store program codes and data for network controller 130. A communication unit 294 may enable network controller 130 to communicate with other network entities.

As noted above, the BS 110 and UE 120 may utilize FDD or TDD. For FDD, the downlink and uplink may be allocated separate frequency channels, and downlink transmissions and uplink transmissions may be sent concurrently on the two frequency channels.

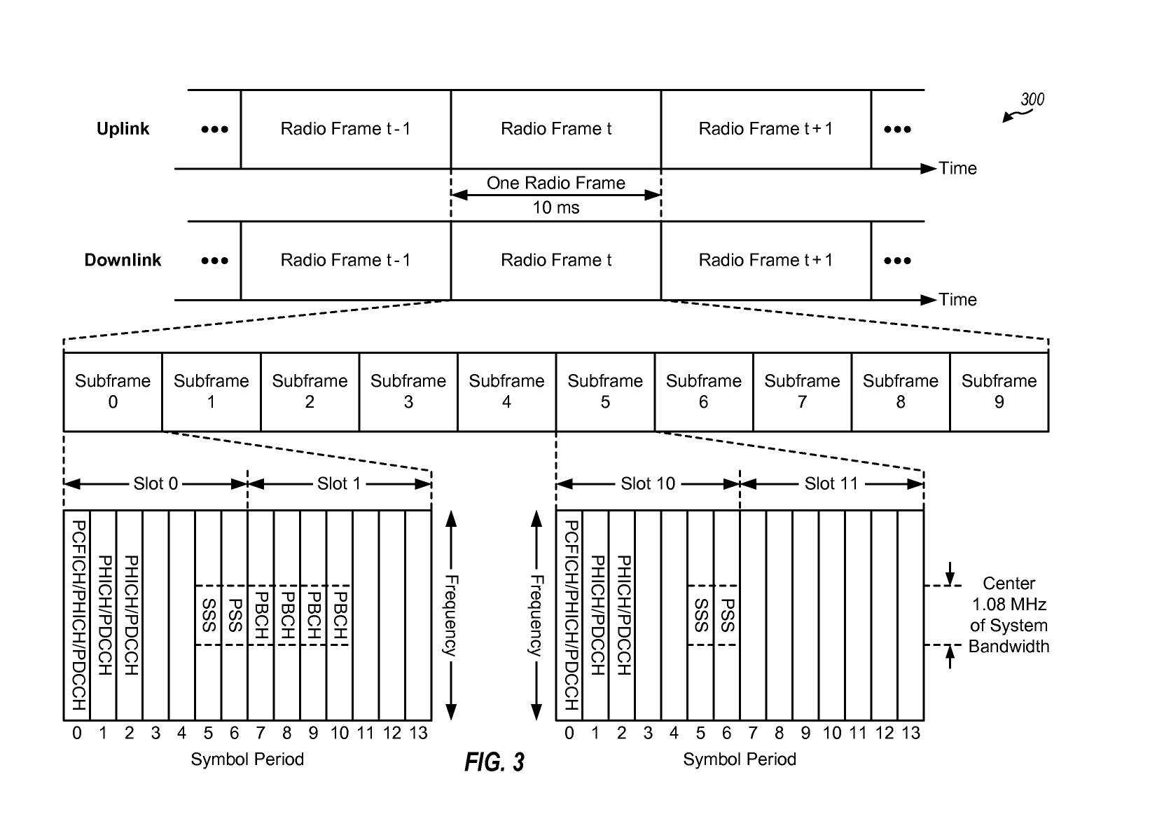

FIG. 3 shows an exemplary frame structure 300 for FDD in LTE. The transmission timeline for each of the downlink and uplink may be partitioned into units of radio frames. Each radio frame may have a predetermined duration (e.g., 10 milliseconds (ms)) and may be partitioned into 10 subframes with indices of 0 through 9. Each subframe may include two slots. Each radio frame may thus include 20 slots with indices of 0 through 19. Each slot may include L symbol periods, e.g., seven symbol periods for a normal cyclic prefix (as shown in FIG. 3) or six symbol periods for an extended cyclic prefix. The 2L symbol periods in each subframe may be assigned indices of 0 through 2L−1.

LTE utilizes orthogonal frequency division multiplexing (OFDM) on the downlink and single-carrier frequency division multiplexing (SC-FDM) on the uplink. OFDM and SC-FDM partition a frequency range into multiple (N_{FFT}) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (N_{FFT}) may be dependent on the system bandwidth. For example, N_{FFT} may be equal to 128, 356, 512, 1024 or 2048 for system bandwidth of 1.25, 2.5, 5, 10 or 20 megahertz (MHz), respectively. The system bandwidth may also be partitioned into a number of subbands, and each subband may cover a range of frequencies, e.g., 1.08 MHz.

The available time frequency resources for each of the downlink and uplink may be partitioned into resource blocks. Each resource block may cover 12 subcarriers in one slot and may include a number of resource elements. Each resource element may cover one subcarrier in one symbol period and may be used to send one modulation symbol, which may be a real or complex value.

In LTE, an eNB may transmit a Physical Control Format Indicator Channel (PCFICH), a Physical HARQ Indicator Channel (PHICH), and a Physical Downlink Control Channel (PDCCH) in a control region of a subframe. The PCFICH may convey the size of the control region. The PHICH may carry acknowledgement (ACK) and negative acknowledgement (NACK) feedback for data transmission sent on the uplink with HARQ. The PDCCH may carry downlink grants, uplink grants, and/or other control information. The eNB may also transmit a Physical Downlink Shared Channel (PDSCH) in a data region of a subframe (not shown in FIG. 3). The PDSCH may carry data for UEs scheduled for data transmission on the downlink.

In LTE, an eNB may also transmit a primary synchronization signal (PSS) and a secondary synchronization signal (SSS) on the downlink in the center 1.08 MHz of the system bandwidth for each cell supported by the eNB. The PSS and SSS may be transmitted in symbol periods 6 and 5, respectively, in subframes 0 and 5 of each radio frame with the normal cyclic prefix, as shown in FIG. 3. The PSS and SSS may be used by the UEs for cell search and acquisition. The eNB may transmit a cell-specific reference signal (CRS) across the system bandwidth for each cell supported by the eNB. The CRS may be transmitted in certain symbol periods of each subframe and may be used by the UEs to perform channel estimation, channel quality measurement, and/or other functions. The eNB may also transmit a Physical Broadcast Channel (PBCH) in symbol periods 0 to 3 in slot 1 of certain radio frames. The PBCH may carry some system information. The eNB may transmit other system information such as system information blocks (SIBs) on the PDSCH in certain subframes.

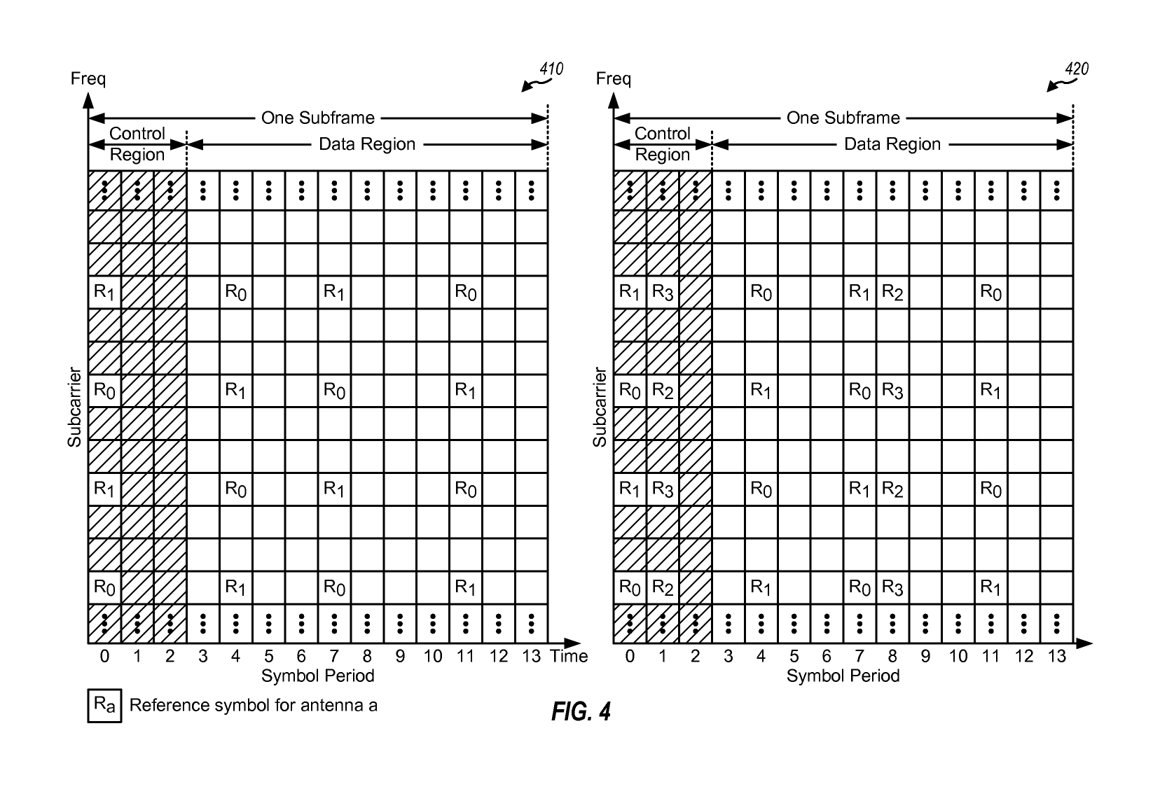

FIG. 4 shows two exemplary subframe formats 410 and 420 for the downlink with the normal cyclic prefix in LTE. A subframe for the downlink may include a control region followed by a data region, which may be time division multiplexed. The control region may include the first M symbol periods of the subframe, where M may be equal to 1, 2, 3 or 4. M may change from subframe to subframe and may be conveyed by the PCFICH in the first symbol period of the subframe. The control region may carry control information. The data region may include the remaining 2L−M symbol periods of the subframe and may carry data and/or other information.

Subframe format 410 may be used for an eNB equipped with two antennas. A CRS may be transmitted from antennas 0 and 1 in symbol periods 0, 4, 7 and 11. A reference signal is a signal that is known a priori by a transmitter and a receiver and may also be referred to as pilot. A CRS is a reference signal that is specific for a cell, e.g., generated based on a cell identity (ID). In FIG. 4, for a given resource element with label Rₐ, a modulation symbol may be transmitted on that resource element from antenna a, and no modulation symbols may be transmitted on that resource element from other antennas. Subframe format 420 may be used for an eNB equipped with four antennas. A CRS may be transmitted from antennas 0 and 1 in symbol periods 0, 4, 7 and 11 and from antennas 2 and 3 in symbol periods 1 and 8. For both subframe formats 410 and 420, a CRS may be transmitted on evenly spaced subcarriers, which may be determined based on the cell ID. Different eNBs may transmit CRSs for their cells on the same or different subcarriers, depending on the cell IDs of these cells. For both subframe formats 410 and 420, resource elements not used for the CRS may be used to transmit data or control information.

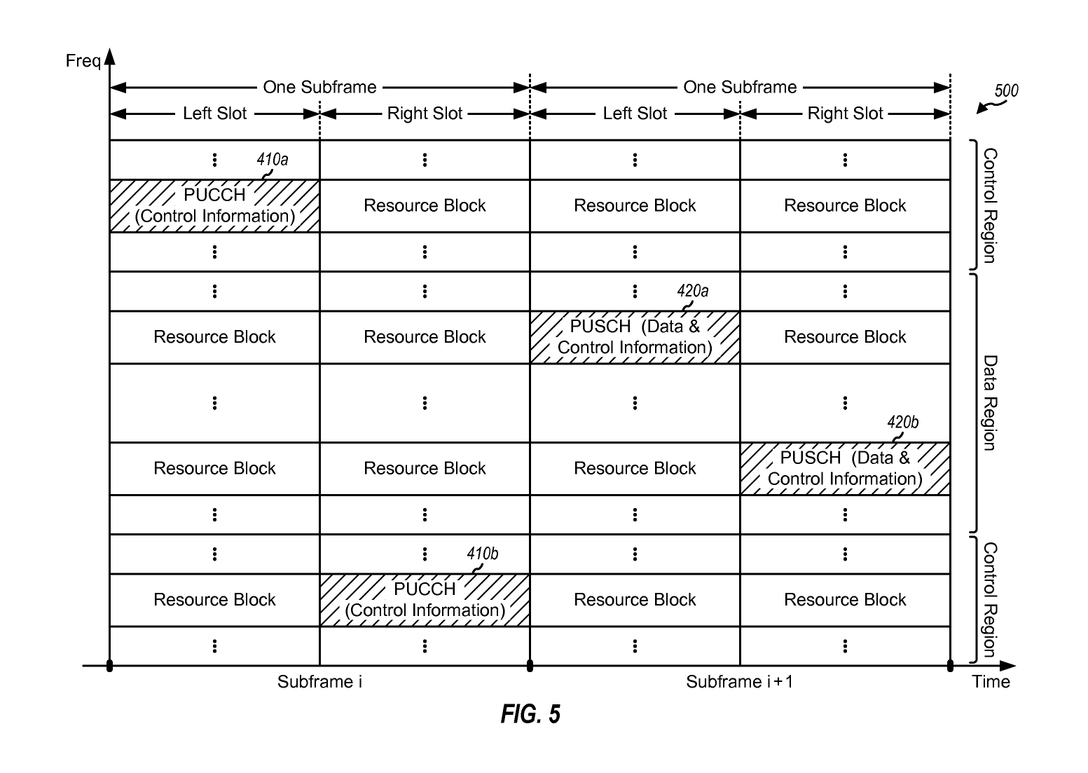

FIG. 5 shows an exemplary subframe format 400 for the uplink in LTE. A subframe for the uplink may include a control region and a data region, which may be frequency division multiplexed. The control region may be formed at the two edges of the system bandwidth and may have a configurable size. The data region may include all resource blocks not included in the control region.

A UE may be assigned resource blocks in the control region to send control information to an eNB. The UE may also be assigned resource blocks in the data region to send data to the eNB. The UE may send control information on a Physical Uplink Control Channel (PUCCH) on assigned resource blocks 510a and 510b in the control region. The UE may send only data, or both data and control information, on a Physical Uplink Shared Channel (PUSCH) on assigned resource blocks 520a and 520b in the data region. An uplink transmission may span both slots of a subframe and may hop across frequency, as shown in FIG. 5.

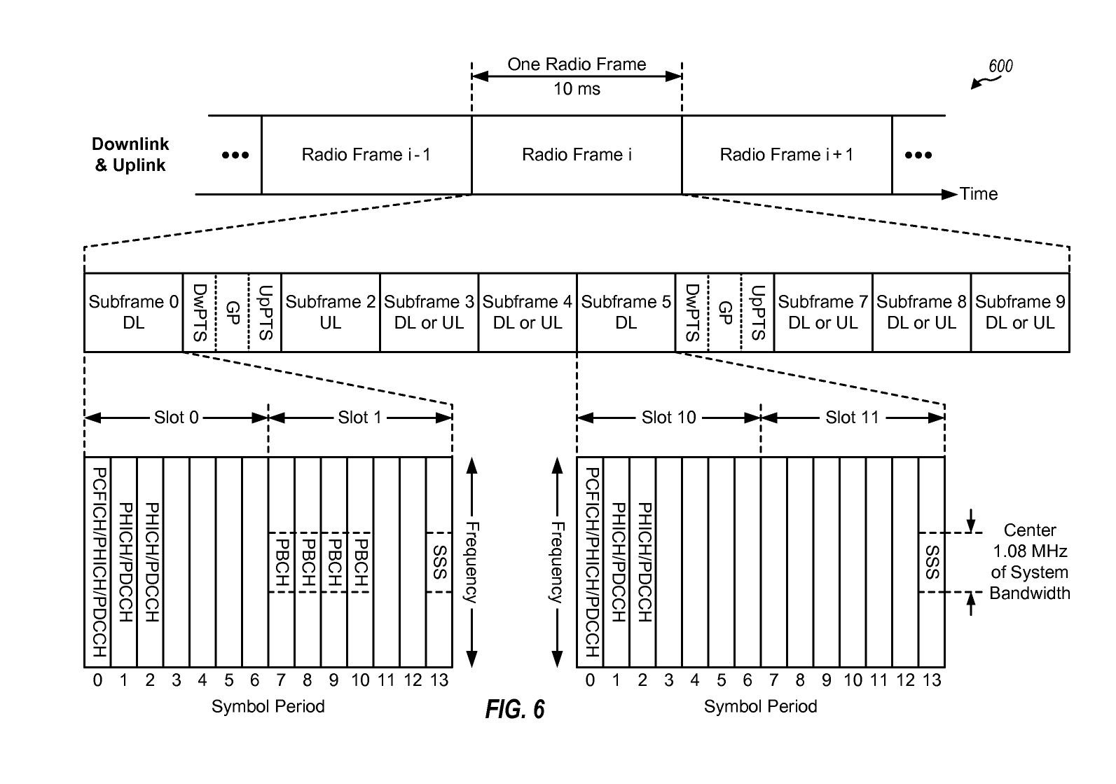

FIG. 6 shows an exemplary frame structure 600 for TDD in LTE. LTE supports a number of downlink-uplink configurations for TDD. Subframes 0 and 5 are used for the downlink (DL) and subframe 2 is used for the uplink (UL) for all downlink-uplink configurations. Subframes 3, 4, 7, 8 and 9 may each be used for the downlink or uplink depending on the downlink-uplink configuration. Subframe 1 includes three special fields composed of (i) a Downlink Pilot Time Slot (DwPTS) used for downlink control channels as well as data transmissions, (ii) a Guard Period (GP) of no transmission, and (iii) an Uplink Pilot Time Slot (UpPTS) used for either a Random Access Channel (RACH) or sounding reference signals (SRS). Subframe 6 may include only the DwPTS, or all three special fields, or a downlink subframe depending on the downlink-uplink configuration. The DwPTS, GP and UpPTS may have different durations for different subframe configurations.

On the downlink, an eNB may transmit the PSS in symbol period 2 of subframes 1 and 6 (not shown in FIG. 6), and the SSS in the last symbol period of subframes 0 and 5. The eNB may transmit the CRS in certain symbol periods of each downlink subframe. The eNB may also transmit the PBCH in subframe 0 of certain radio frames.

The various frame structures, subframe formats, physical channels, and signals in LTE are described in 3GPP TS 36.211, entitled “Evolved Universal Terrestrial Radio Access (E-UTRA); Physical Channels and Modulation,” which is publicly available.

Those skilled in the art will recognize that the interference management techniques presented herein may be implemented using any suitable combination of hardware and/or software components. According to certain aspects, various operations of such techniques may be implemented using one or more “software configurable” programmable processors.

### Subframe Dependent Transmission Power Control

Certain aspects of the present disclosure provide interference management by allowing different transmission power levels to be used for uplink transmissions in different types of subframes. As will be described in greater detail below, subframe type-dependent transmission power control may be achieved by utilizing one or more transmission power control loops (e.g., independent loops or a single loop with one or more offsets).

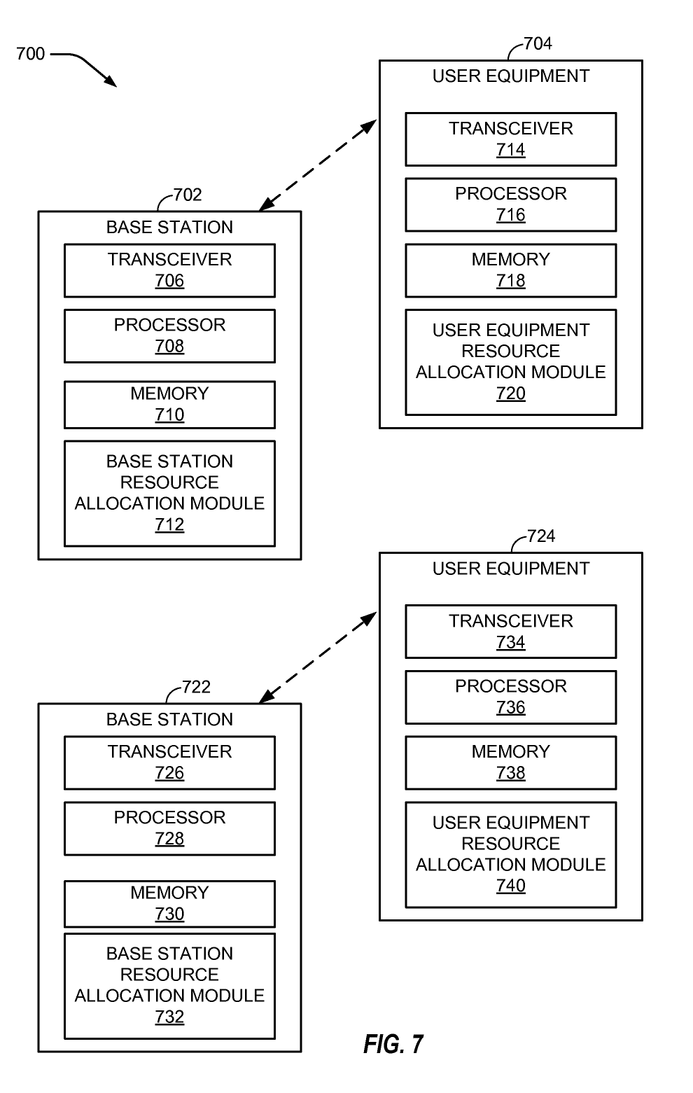

FIG. 7 illustrates an example communication system 700 in which the interference management techniques described herein may be utilized. As illustrated, the wireless communication system 700 may include BSs 702, 722 and UEs 704, 724 served by BS 702, 722, respectively. BSs 702, 722 may be located in different cells that potentially interfere with each other. According to certain aspects, the communication system 700 may be a heterogenerous network and the BSs 702, 722 may be a combination of a macro BS, a Femto BS, a pico BS, and the like. According to certain aspects, the wireless communication system 700 may be an LTE or an LTE-A system.

BSs 702, 722 may include transceivers 706, 716 configured to transmit and receive data and/or control information and/or any other type of information described herein with reference to any of the systems, methods, apparatus and/or computer program products to and from UEs 704, 724, respectively. For example, transceivers 706, 716 may be configured to transmit and/or receive time and/or frequency resource partitioning information, data, and control channels.

BSs 702, 722 may also include various processors 708, 728 and memory 710, 730. Processors 708, 728 may be configured to perform one or more of the interference management functions described herein. The BSs 702, 722 may include memory 710, 730, for example, each storing instructions executable by the processors 708, 728, to perform various operations described herein.

BSs 702, 722 may also include BS resource allocation modules 712, 732 configured to allocate resources for interference management. The resources allocated may include, but are not limited to, time and/or frequency transmission resources. For example, the resource allocation modules 712, 732 may be configured to transmit, generate and/or process resource partitioning information between different power classes of BSs. According to certain aspects, the resource allocation modules 712, 732 may be configured to generate power control information for interference management as described herein.

The wireless communication system 700 may also include UEs 704, 724 served by BSs 702, 722, respectively, and located in corresponding cells managed by BSs 702, 722.

UEs 704, 724 may include transceivers 714, 734 configured to transmit and receive data and/or control information and/or any other type of information described herein to and from BSs 702, 722, respectively. For example, transceivers 714, 734 may be configured to transmit and/or receive time and/or frequency resource partitioning information and power control information to vary transmission power of uplink transmissions in different types of subframes. According to certain aspects, transceivers 714, 734 may be configured to transmit in different types of subframes including, but not limited to, usable, non-usable and flexibly usable subframes. Transceivers 714, 734 may be configured to receive data and control channels.

UEs 704, 724 may also include various processors 716, 736 and memory 718, 738. Processors 716, 736 may be configured to perform one or more of the functions described herein with reference to any of the systems, methods, apparatus and/or computer program products. The UEs 704, 724 may include memory 718, 738 for example, each storing instructions executable by the processors 716, 736, to perform various operations described herein.

UEs 704, 724 may also include UE resource allocation modules 720, 740 configured to receive and process resource allocation information for interference management. For example, the UE resource allocation modules 720, 740 may be configured to receive and process resource partitioning information between different power classes of BSs. According to certain aspects, the resource allocation modules 720, 740 may also be configured to receive power control information and vary transmit power of uplink transmissions in various types of subframes accordingly.

The above-referenced resource allocation modules may be configured to perform resource partitioning to protect control and/or data transmissions from DL and/or UL interference. As noted above, the resource allocation may be in the time and/or frequency domains. For example, for time-domain resource partitioning for the UL, three types of subframes may be defined. The U, N and X subframes may be defined. U subframes may be usable for a given cell, and typically free of interference from cells of different classes. N subframes refer non-usable subframes that are typically not usable by a given cell in order to avoid excessive interference to cells of different classes. X subframes may be usable in some cases, based on the BS implementation for the cell.

UEs 704, 724 aware of the management of subframe types may typically transmit in U subframes for best interference protection (as transmissions in these subframes in neighboring cells are restricted), while avoiding transmitting in N subframes (at least on best-effort basis) in order to avoid excessive interference. UEs 704, 724 may optionally use the X subframes, as dictated by decisions by the BSs 702, 722 for the given cell. Applying this approach to subframe usage, U subframes may generally be expected to be used by the UEs 704, 724 most often, X subframes may (or may not) be optionally used and N subframes are expected to be used least (to avoid excessive interference when possible).

When a UE served by a macro BS is aware of the above subframe types, and is geographically close to a cell managed by a Femto BS, the UE may receive instructions to not transmit in macro N subframes (as such is likely to cause high interference to the Femto cell). The Femto cell, which is not accessible to the UE, thus would not see strong interference from the UE served by the macro BS. Accordingly, UEs served by the Femto BS may then transmit in U subframes for UL transmissions.

When a UE served by a macro BS is unaware of the above subframe types, the macro BS may still perform UL scheduling such that the UE served by the macro BS is not scheduled in N subframes, for example, at least on a best-effort basis.

Applying the above scenarios, the complementary nature of the U and N subframes in neighboring cells (e.g., a subframe considered a U subframe in one cell is typically considered an N subframe in an interfering cell) coupled with appropriate scheduling by the BS in a cell, may enable a UE served by a Femto BS to avoid experiencing strong UL interference from UEs served by a macro BS and that are geographically near the Femto cell. The UEs served by the Femto BS may therefore avoid this interference while transmitting U subframes.

However, other methods for reducing interference when other types of subframes (other than the U subframe) are transmitted may also be desirable. According to certain aspects, a BS may avoid scheduling the UE during the non-U subframe. Such limitation, however, may impact the UL performance of the Femto cell, because the number of U subframes in the Femto cell may be limited.

According to certain aspects presented herein, subframe type-dependent transmission power control may be utilized in an effort to help manage interference. In any case, a higher transmission power level may be utilized in un-protected or less-protected subframes than in more protected subframes. In other words, the protection of “U” subframes allows a lower uplink transmission power to be used, while an increased transmission power on other subframe types (e.g., “N” and “X” subframes) may help compensate for some level of interference.

This approach may be employed, for example, in the UL of a Femto cell to enable potential UL transmissions over all subframes and to handle the interference variations over different subframes.

According to certain aspects, transmission power control may be accomplished by utilizing noise padding to artificially impact a decision made on transmit power in one or more power control loops. When noise padding is utilized, the relative noise padding may be set at a relatively high level (e.g., 20 dB) in order to balance transmissions on the DL and UL. According to certain aspects, the noise padding may be set such that the Interference Over Thermal (IoT) level operated on the UL of the Femto cell is increased to a higher level. The UEs served by the Femto BS may then be forced to transmit with higher power. The overall IoT variations (hence power control variations) may be maintained at a level much smaller than the original case. In another embodiment, instead of a fixed offset, a noise padding loop may vary based, at least on the UL interference level at the Femto cell.

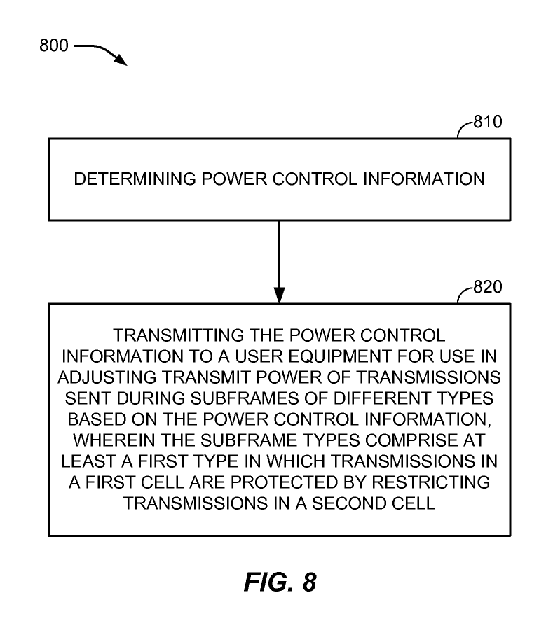

FIG. 8 illustrates example operations 800 that may be performed, for example, by a base station (e.g., an eNB) to perform interference management. The operations 800 begin, at 802, by determining power control information. At 804, the BS transmits the power control information to a UE for use in adjusting transmit power of transmissions sent during subframes of different types based on the power control information, wherein the subframe types comprise at least a first type in which transmissions in a first cell are protected by restricting transmissions in a second cell.

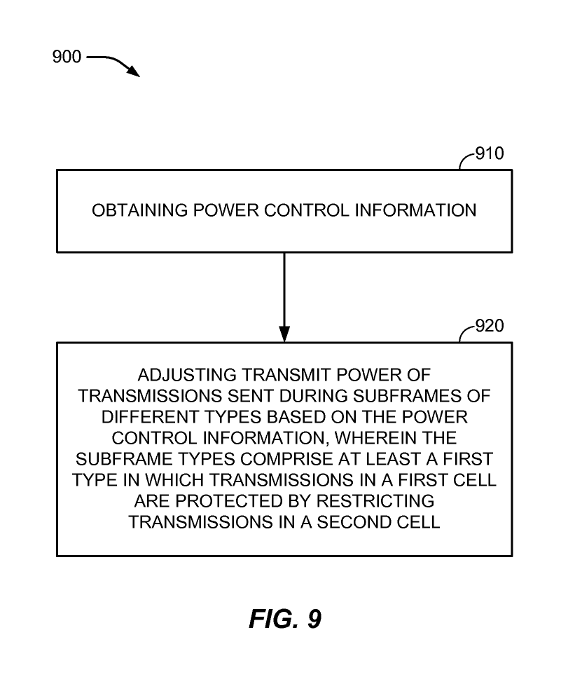

FIG. 9 illustrates example operations 900 that may be performed, for example, by a UE to perform interference management. The operations 900 begin, at 902, by obtaining power control information (e.g., transmitted from the BS). At 904, the UE adjusts transmit power of transmissions sent during subframes of different types based on the power control information, wherein the subframe types comprise at least a first type in which transmissions in a first cell are protected by restricting transmissions in a second cell.

The power control information may be designed to vary transmission power for different subframe types. As described herein, the power control information may take various forms, such as separate subframe type-dependent transmission power control (TPC) commands or a single transmission power control setting for protected (e.g., U subframes) with one or more offsets for adjusting (e.g., increasing) transmission power of UL transmissions in different subframe types.

Depending on a particular implementation, a single or multiple power control loops may be maintained to affect subframe type-dependent transmission power control to manage interference. For example, according to certain aspects, two or more transmission power control loops may be maintained, with each loop accounting for subframes having a same or similar UL interference characteristics.

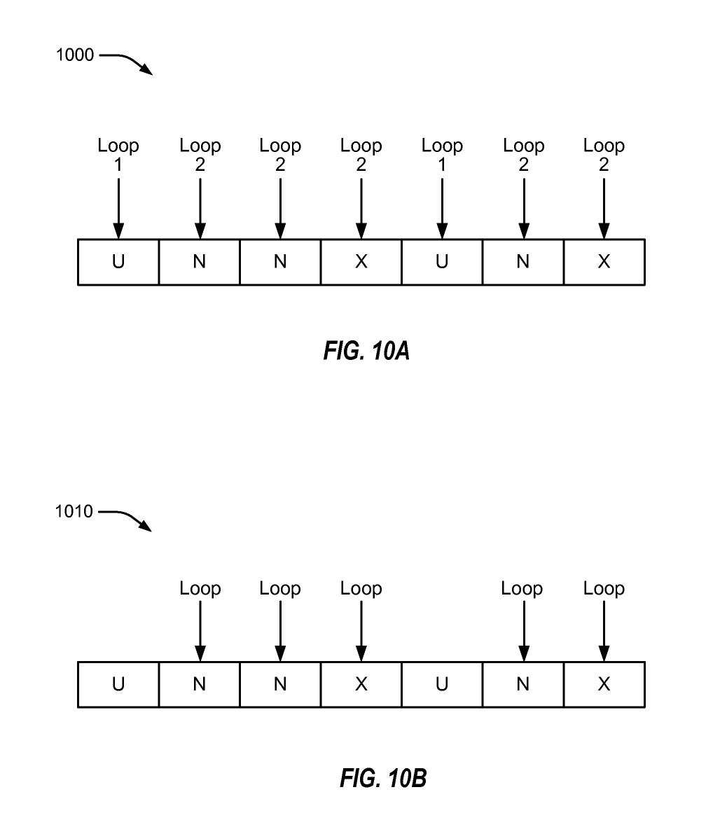

For example, as illustrated in FIG. 10A, two transmission power control loops may be maintained, one for “U” subframes and the other for other subframe types. Typically, it is expected that less UL transmission power will be needed for protected (e.g. “U”) than for other subframe types, as “U” subframes are expected to see much less UL interference.

In some case, for example, where if there is no significant UL interference in the “U” subframes from Macro UEs or UEs of other femto cells, power control (e.g., via noise padding) may be eliminated for “U” subframes. By doing so, it may be possible to utilize a single transmission power control loop. For example, as illustrated in FIG. 10B, a single transmission power control loop may be used to adjust transmission power control, with adjustments only selectively applied to some subframes (instead to all subframes).

For embodiments such as those shown in FIGS. 10A and 10B, power control for the U and the non-U subframes may therefore vary in a subframe-dependent manner also.

According to certain aspects, for each power control loop, on or more subframe-dependent open loop offsets may be maintained for different subframe types. These offsets may be semi-statically configured or dynamically indicated (e.g., broadcast or unicast). According to certain aspects, the offset may be aligned with differences of noise padding for different subframes.

To minimize UE transmit power, a Femto BS may schedule UEs it serves in the subframes with the lower (or no) transmit power adjustments. The UEs may therefore be prioritized to use U subframes first, with zero or minimal transmit power adjustments (or noise padding), which may help improve battery life of the UEs. When necessary, the Femto BS may also schedule UL transmissions on power-adjusted non-U subframes, for example, in an effort to improve UL performance (but at the expense of battery life, depending on the amount of interference seen by these non-U subframes and the corresponding increase in transmit power).

The scenarios and embodiments described herein may be applied to any HetNet, including, but not limited to, Femto-to-Femto network, Macro-to-Pico network and/or any other type of HetNet where the interfered BS may implement any of the functions described herein.

The techniques described herein may be implemented using any suitable means, which may include any suitable combination of hardware and/or software components. In one aspect, the aforementioned means may be processor(s), such as those described in the Figures above, configured to perform the functions described above. In another aspect, the aforementioned means may be a module or any apparatus configured to perform the functions recited by the aforementioned means.

The terms “module”, “component,” and the like, are intended to refer to a computer-related entity, either hardware, firmware, a combination of hardware and software, software, or software in execution. For example, a component may be, but is not limited to being, a process running on a processor, a processor, an object, an executable, a thread of execution, a program and/or a computer. By way of illustration, both an application running on a computing device and the computing device may be a component. One or more components may reside within a process and/or thread of execution and a component may be localized on one computer and/or distributed between two or more computers. In addition, these components may execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

Those skilled in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those skilled in the art would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware, software, or combinations of both, depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in random access memory (RAM), read only memory (ROM), programmable ROM (PROM), electrically programmable ROM (EPROM), electrically erasable ROM (EEPROM), registers, hard disk, a removable disk, a CD-ROM, or any other form of storage medium known in the art. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM) and direct Rambus RAM (DRRAM). An exemplary storage medium is coupled to the processor such that the processor may read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that may be accessed by a general purpose or special purpose computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

As used herein, a phrase referring to “at least one of” a list of items refers to any combination of those items, including single members. As an example, “at least one of: a, b, or c” is intended to cover: a, b, c, a-b, a-c, b-c, and a-b-c.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method for mitigating interference in a wireless communications network, comprising:
obtaining power control information; and
adjusting transmit power of transmissions sent during subframes of different types based on the power control information, wherein the subframe types comprise at least a first type in which transmissions in a first cell are protected by restricting transmissions in a second cell.

2. The method of claim 1, wherein:
the wireless communications network comprises a heterogeneous network; and
the first and second cells are of different power class types.

3. The method of claim 1, wherein adjusting the transmit power comprises:
utilizing a first transmit power level for transmissions sent in subframes of the first type that is lower than a second transmit power level used in subframes of a second type.

4. The method of claim 3, wherein the power control information comprises:
an indication of the first transmit power level for transmissions sent in subframes of the first type; and
an indication of an offset usable to determine the second transmit power level based on the first transmit power level.

5. The method of claim 1, wherein the power control information comprises:
information received in one or more transmit power control (TPC) commands.

6. The method of claim 1, wherein the power control information comprises:
information for adjusting a first transmit power level for transmissions sent in subframes of the first type; and
information for adjusting a second transmit power level for transmissions sent in subframes of the second type.

7. The method of claim 6, wherein:
the information for adjusting the first transmit power level is derived based on at least a first power control loop.

8. The method of claim 7, wherein the first power control loop is derived based in part on a noise padding scheme.

9. The method of claim 7, wherein:
the information for adjusting the second transmit power level is derived based on at least a second power control loop.

10. The method of claim 9, wherein the first power control loop is derived based in part on a first noise padding scheme and the second power control loop is derived based in part on a second noise padding scheme.

11. The method of claim 10, wherein the first noise padding scheme utilizes zero noise padding.

12. The method of claim 6, wherein:
the information for adjusting the second transmit power level is derived based on an open-loop offset applied the information for adjusting the first transmit power level.

13. A method for mitigating interference in a wireless communications network, comprising:
determining power control information; and
transmitting the power control information to a user equipment (UE) for use in adjusting transmit power of transmissions sent during subframes of different types based on the power control information, wherein the subframe types comprise at least a first type in which transmissions in a first cell are protected by restricting transmissions in a second cell.

14. The method of claim 13, wherein:
the wireless communications network comprises a heterogeneous network; and
the first and second cells are of different power class types.

15. The method of claim 13, wherein the UE adjusts the transmit power by:
utilizing a first transmit power level for transmissions sent in subframes of the first type that is lower than a second transmit power level used in subframes of a second type.

16. The method of claim 15, wherein the power control information transmitted to the UE comprises:
an indication of the first transmit power level for transmissions sent in subframes of the first type; and
an indication of an offset usable to determine the second transmit power level based on the first transmit power level.

17. The method of claim 13, wherein the power control information comprises:
information received in one or more transmit power control (TPC) commands.

18. The method of claim 13, wherein the power control information transmitted to the UE comprises:
information for adjusting a first transmit power level for transmissions sent in subframes of the first type; and
information for adjusting a second transmit power level for transmissions sent in subframes of the second type.

19. The method of claim 18, wherein:
the information for adjusting the first transmit power level is derived based on at least a first power control loop.

20. The method of claim 19, wherein a noise padding scheme is applied for the first power control loop.

21. The method of claim 19, wherein:
the information for adjusting the second transmit power level is derived based on at least a second power control loop.

22. The method of claim 21, wherein a first noise padding scheme is applied for the first power control loop and a second noise padding scheme is applied for the second power control loop.

23. The method of claim 22, wherein the first noise padding scheme utilizes zero noise padding.

24. The method of claim 18, wherein:
the information for adjusting the second transmit power level is derived based on an open-loop offset applied the information for adjusting the first transmit power level.

25. An apparatus for mitigating interference in a wireless communications network, comprising:
obtaining power control information; and
adjusting transmit power of transmissions sent during subframes of different types based on the power control information, wherein the subframe types comprise at least a first type in which transmissions in a first cell are protected by restricting transmissions in a second cell.

26. The apparatus of claim 25, wherein:
the wireless communications network comprises a heterogeneous network; and
the first and second cells are of different power class types.

27. The apparatus of claim 25, wherein the means for adjusting the transmit power utilizes a first transmit power level for transmissions sent in subframes of the first type that is lower than a second transmit power level used in subframes of a second type.

28. The apparatus of claim 27, wherein the power control information comprises:
an indication of the first transmit power level for transmissions sent in subframes of the first type; and
an indication of an offset usable to determine the second transmit power level based on the first transmit power level.

29. The apparatus of claim 25, wherein the power control information comprises:
information received in one or more transmit power control (TPC) commands.

30. The apparatus of claim 25, wherein the power control information comprises:
information for adjusting a first transmit power level for transmissions sent in subframes of the first type; and
information for adjusting a second transmit power level for transmissions sent in subframes of the second type.

31. The apparatus of claim 30, wherein:
the information for adjusting the first transmit power level is derived based on at least a first power control loop.

32. The apparatus of claim 31, wherein the first power control loop is derived based in part on a noise padding scheme.

33. The apparatus of claim 31, wherein:
the information for adjusting the second transmit power level is derived based on at least a second power control loop.

34. The apparatus of claim 33, wherein the first power control loop is derived based in part on a first noise padding scheme and the second power control loop is derived based in part on a second noise padding scheme.

35. The apparatus of claim 34, wherein the first noise padding scheme utilizes zero noise padding.

36. The apparatus of claim 30, wherein:
the information for adjusting the second transmit power level is derived based on an open-loop offset applied the information for adjusting the first transmit power level.

37. An apparatus for mitigating interference in a wireless communications network, comprising:
means for determining power control information; and
means for transmitting the power control information to a user equipment (UE) for use in adjusting transmit power of transmissions sent during subframes of different types based on the power control information, wherein the subframe types comprise at least a first type in which transmissions in a first cell are protected by restricting transmissions in a second cell.

38. The apparatus of claim 37, wherein:
the wireless communications network comprises a heterogeneous network; and
the first and second cells are of different power class types.

39. The apparatus of claim 37, wherein the UE adjusts the transmit power by:
utilizing a first transmit power level for transmissions sent in subframes of the first type that is lower than a second transmit power level used in subframes of a second type.

40. The apparatus of claim 39, wherein the power control information transmitted to the UE comprises:
an indication of the first transmit power level for transmissions sent in subframes of the first type; and
an indication of an offset usable to determine the second transmit power level based on the first transmit power level.

41. The apparatus of claim 37, wherein the power control information comprises:
information received in one or more transmit power control (TPC) commands.

42. The apparatus of claim 37, wherein the power control information transmitted to the UE comprises:
information for adjusting a first transmit power level for transmissions sent in subframes of the first type; and
information for adjusting a second transmit power level for transmissions sent in subframes of the second type.

43. The apparatus of claim 42, wherein:
the information for adjusting the first transmit power level is derived based on at least a first power control loop.

44. The apparatus of claim 43, wherein a noise padding scheme is applied for the first power control loop.

45. The apparatus of claim 43, wherein:
the information for adjusting the second transmit power level is derived based on at least a second power control loop.

46. The apparatus of claim 45, wherein a first noise padding scheme is applied for the first power control loop and a second noise padding scheme is applied for the second power control loop.

47. The apparatus of claim 46, wherein the first noise padding scheme utilizes zero noise padding.

48. The apparatus of claim 42, wherein:
the information for adjusting the second transmit power level is derived based on an open-loop offset applied the information for adjusting the first transmit power level.

49. An apparatus for mitigating interference in a wireless communications network, comprising:
at least one processor configured to obtain power control information and adjust transmit power of transmissions sent during subframes of different types based on the power control information, wherein the subframe types comprise at least a first type in which transmissions in a first cell are protected by restricting transmissions in a second cell; and
a memory coupled with the at least one processor.

50. An apparatus for mitigating interference in a wireless communications network, comprising:
at least one processor configured to determine power control information and transmit the power control information to a user equipment (UE) for use in adjusting transmit power of transmissions sent during subframes of different types based on the power control information, wherein the subframe types comprise at least a first type in which transmissions in a first cell are protected by restricting transmissions in a second cell; and
a memory coupled with the at least one processor.

51. A computer program product comprising a computer readable medium having instructions for mitigating interference in a wireless communications network stored thereon, the instructions executable by one or more processors for:
obtaining power control information; and
adjusting transmit power of transmissions sent during subframes of different types based on the power control information, wherein the subframe types comprise at least a first type in which transmissions in a first cell are protected by restricting transmissions in a second cell.

52. A computer program product comprising a computer readable medium having instructions for mitigating interference in a wireless communications network stored thereon, the instructions executable by one or more processors for:
determining power control information; and
transmitting the power control information to a user equipment (UE) for use in adjusting transmit power of transmissions sent during subframes of different types based on the power control information, wherein the subframe types comprise at least a first type in which transmissions in a first cell are protected by restricting transmissions in a second cell.
